(19) United States
(12) Patent Application Publication
(10) Pub. No.: US 2001/0031057 A1
(43) Pub. Date: Oct. 18, 2001

(54) Method and apparatus for producing spatially distributed sound into a set of headphones

(76) Inventor: Martin Pineau, Verdun (CA)

Correspondence Address: Michael B Lasky, Altera Law Group LLC, 10749 Bren Road East Opus 2, Minneapolis, MN, 55343, US

(21) Appl. No.: 09/748,508

(22) Filed: Dec. 26, 2000

Related U.S. Application Data
(60) Provisional application No. 60/171,658, filed on Dec. 27, 1999.

(51) Int. Cl. H04R 5/02

(52) U.S. Cl. 381/309; 381/310; 381/371

(57) ABSTRACT

An apparatus and method for producing spatially distributed sound into a set of headphones having left and right ear-cups. An input receives a sound signal including a left channel signal, a right channel signal, a front channel signal and optionally a rear channel signal. The left and right are directly outputted by corresponding transducers in either the left or right ear-cup. The front and rear channels are each divided in two, so that they can be fed to transducers on both the left and right ear-cups. A set of headphones provided with such an apparatus is also provided.

### FIELD OF THE INVENTION

The present invention relates to the reproduction of stereo and surround sound with headphones, and is more particularly directed to an improved alternative method and apparatus for producing “out of head” spatially distributed sound effects into a set of headphones.

### BACKGROUND OF THE INVENTION

Headphones are a popular way of privately listening to stereophonic music and sound recordings. Researchers committed to sonic realism have therefore been attempting to find ways to improve the performance of sound reproducing headphone systems.

The main drawback of headphones as a means of reproducing stereophonic recordings, is the over separation of the left and right sound channels, which leads to less than realistic sonic perception. The resulting sound effect perceived by the listener can best be described as coming from three distinct locations, namely hard left, dead center, in the middle of the head and hard right. This pattern is illustrated in FIG. 1 (prior art).

In every day sonic perception, be it at a concert, at home or even on the streets, humans perceive sound by virtue of ‘HRTF’, Head Related Transfer Functions. This phenomenon has been well documented since the 1970's. The problem with HRTF is that in order to properly address this ‘condition of sonic satisfaction’ with headphones, the recording itself has to be tailored accordingly, such as with BINAURAL recordings which are designed to feed to the ear/brain apparatus all of the sonic cues required for headphone listeners to ‘believe’ that what they are listening to is realistic. A serious drawback of this technique is that BINAURAL recordings are not appropriate for a two loudspeaker stereophonic sound reproduction system that can be found in almost all homes today. In other words, a major problem of the industry is that recordings made for home reproduction sound systems, are incompatible with headphones, and recordings made for headphones are incompatible with home reproduction sound systems.

With the increasing popularity of surround sound reproduction of movies and music over home entertainment surround sound reproduction systems, the gap between conventional headphones and the sonic information to be reproduced is getting wider.

There have been numerous attempts to alleviate this situation, including cross-feed processor designs that purport to recreate a HRTF type of reproduction out of any given sonic material, as well as other surround sound over headphone schemes, but they require a complicated assortment of amplification in order to reproduce the multiple channels associated with surround sound reproduction.

### OBJECTS AND SUMMARY OF THE INVENTION

It is therefore an object of the present invention to provide a method and apparatus that produces a spatially distributed sound into a set of earphones, effectively getting the perceived origin of the sound “out of the listener's head”.

Another object of the invention is to provide such a method and apparatus that are compatible with any given stereophonic or surround sound system.

The present invention therefore provides an apparatus for producing spatially distributed sound into a set of headphones having left and right ear-cups. The apparatus includes an input for receiving a sound signal. The sound signal itself includes a left channel signal, a right channel signal and a front channel signal. Dividing means are provided, for dividing the front channel signal into two secondary front channel signals. The apparatus also includes left output means for outputting the left channel signal and one of the secondary front channel signals into the left ear-cup, and right output means for outputting the right channel signal and another one of the secondary front channel signals into the right ear-cup.

Preferably, the sound signal also includes a rear channel signal. Accordingly, in this embodiment, the dividing means are adapted to divide the rear channel signal into two secondary rear channel signals. The left output means are also adapted to output one of said secondary rear channel signals into the left ear-cup, and the right output means are adapted to output another one of said secondary rear channel signals into the right ear-cup.

The present invention also provides a set of headphones having a left earcup, a right ear-cup and including an apparatus as described above.

In accordance with another aspect of the invention, there is also provided a method for producing spatially distributed sound into a set of headphones having left and right ear-cups. The method includes the steps of:

a) receiving a sound signal including a left channel signal, a right channel signal, a front channel signal, and preferably a rear channel signal.

b) dividing the front channel signal into two secondary front channel signals, and if provided, the rear channel signal into two secondary rear channel signals;

c) outputting the left channel signal and one of the secondary front channel signals into the left ear-cup. One of the secondary rear channel signals may also be outputted into the left ear-cup; and

d) outputting the right channel signal and another one of the secondary front channel signals into the right ear-cup. Similarly, another one of the secondary channel signals may be outputted into the right ear-cup.

Advantageously, the method and apparatus according to the present invention are respectful of the fed sonic information, in that no false or synthesized signals are introduced. Also, since no additional amplification of the signal is involved, no additional power supply is required, which removes the risks of diminishing the performance of any given high-end sound system.

The present invention will be better understood upon reading the following description of preferred embodiments thereof made with reference to the appended drawings.

### BRIEF DESCRIPTION OF THE DRAWINGS

FIG. 1 (prior art) is a schematic representation of stereophonic perception with conventional headphones.

FIG. 2 is a diagram representing an apparatus according to a preferred embodiment of the invention.

FIG. 3 is a diagram representing transducers distributed in the ear-cups of headphones according to a first preferred embodiment of the invention.

FIG. 4 is a schematic representation of stereophonic perception and virtual point sources according to the embodiment of FIG. 3.

FIG. 5 is a diagram representing transducers distributed in the ear-cups of headphones according to a second preferred embodiment of the invention, where the rear channel is disconnected.

FIG. 6 is a diagram representing an apparatus according to the embodiment of FIG. 5.

FIG. 7a is a representation of pattern of perception for headphones incorporating a 3D-processor in the stereo mode; and

FIG. 7b is a representation of pattern of perception for headphones incorporating a 3D-processor in the surround mode.

FIG. 8a shows the perception effects of positive phase switching of the front and rear channel signals;

FIG. 8b shows the perception effects of negative phase switching of the front and rear channel signals.

FIG. 8c shows the perception effects of negative phase switching of the front channel signal and positive phase switching of the rear channel signal; and

FIG. 8d shows the perception effects of positive phase switching of the front channel signal and negative phase switching of the rear channel signal.

FIGS. 9a and 9b are schematic representations of ear-cup assemblies according to various embodiments of the present invention.

FIG. 10 is a schematic representation of a spiral acoustic delay assembly.

FIG. 11 is a block diagram representation of the electrical circuitry for an apparatus according to the present invention.

FIG. 12 is a circuit diagram for FIG. 11.

FIG. 13a is a diagram representation of a switch used for controlling the phase of the front channel; and

FIG. 13b is a diagram representation of a switch used for controlling the phase of the rear channel.

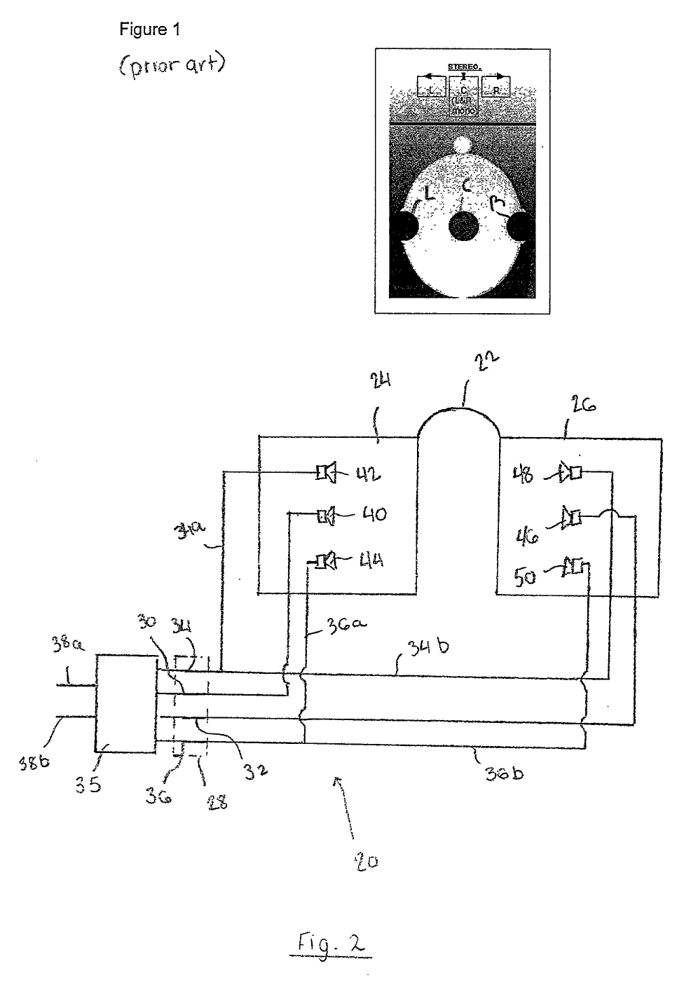

### DESCRIPTION OF PREFERRED EMBODIMENTS OF THE INVENTION

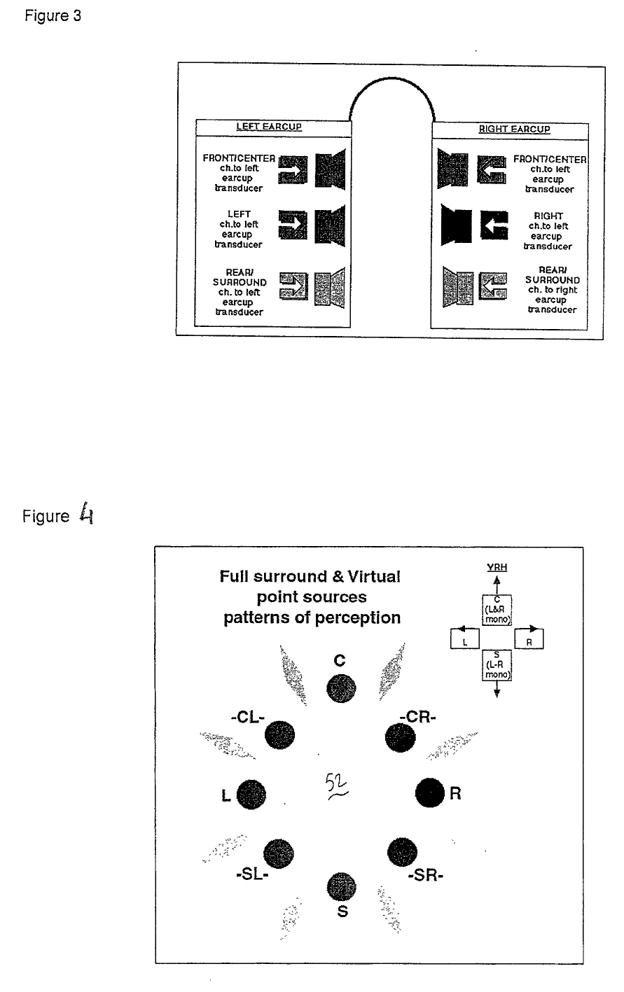

Referring to FIG. 2, there is shown a diagram representing an apparatus 20 according to a preferred embodiment of the present invention. The apparatus 20 is for producing spatially distributed sound into a set of earphones 22 having a left ear-cup 24 and a right ear-cup 26.

The apparatus 20 first includes an input 28 for receiving a sound signal. The sound signal itself includes a left channel signal 30, a right channel signal 32, and a front channel signal 34, also designed by the term center channel signal. Preferably, in the case where a surround sound effect is desired, a rear or surround channel signal 36 is also included.

The apparatus 20 also includes dividing means for dividing the front channel signal 34 into two secondary front channel signals 34a and 34b. For better results, it is preferable that both secondary front channel signals 34a and 34b be identical. Preferably, the dividing means are simply embodied by two wires splitting the concerned signal, but of course any other appropriate means could be used. Similarly, if a rear channel signal 36 is provided, it is also divided by the dividing means into two preferably equal secondary rear channel signals 36a and 36b.

Left output means are provided for outputting components of the sound signal into the left ear-cup 24. In the preferred embodiment, the left output means are embodied by first left transducer 40 outputting the left channel signal 30, second left transducer 42 outputting the secondary front channel signal 34a, and third left transducer 44 outputting the secondary rear channel signal 36a.

Similarly, right output means are provided for outputting components of the sound signal into the right ear-cup 26. The right output means are preferably embodied by first right transducer 46 outputting the right channel signal 32, second left transducer 48 outputting the secondary front channel signal 34b, and third left transducer 50 outputting the secondary rear channel signal 36b.

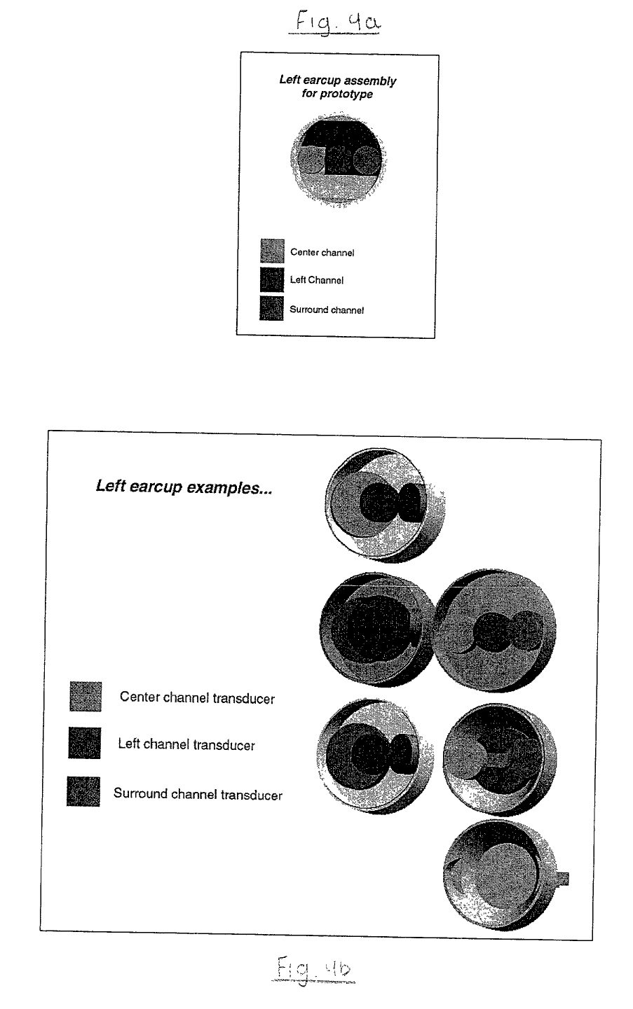

The transducers 40, 42, 44, 46, 48 and 50 may be placed in various arrangements in each ear-cup, provided that a left, a center and a surround channel is present in each ear-cup. After experimentation, the following transducer array per ear-cup, illustrated in FIG. 9a, has been found to be quite efficient:,

Center channel: at midpoint towards the front of the listeners head;

Left/right channel: rearward of the center channel;

Rear channel: at the rearmost of the preceding two channels.

FIG. 9b shows examples of possible alternate distribution of the transducers in their respective ear-cup.

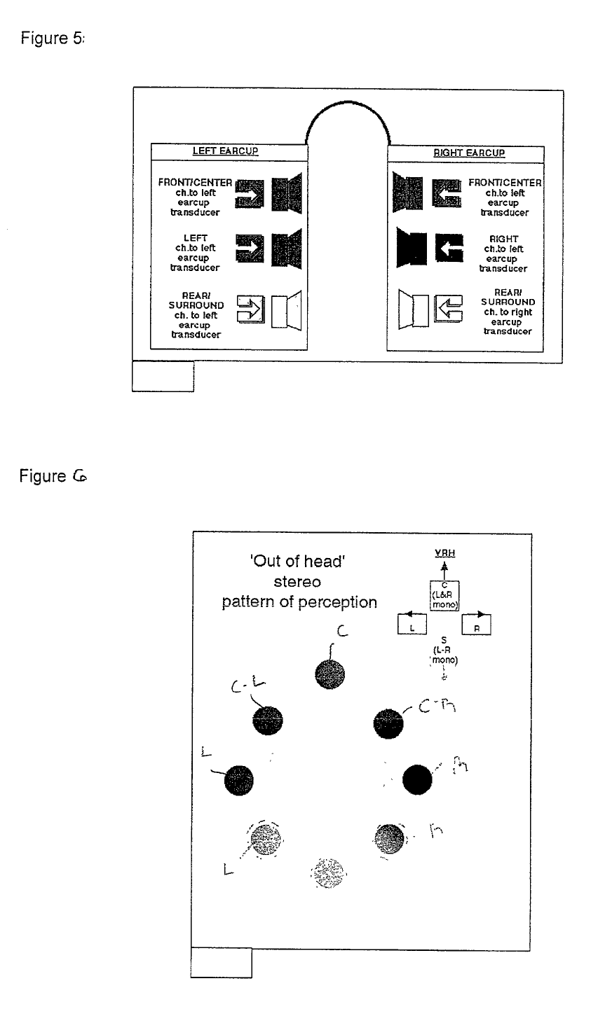

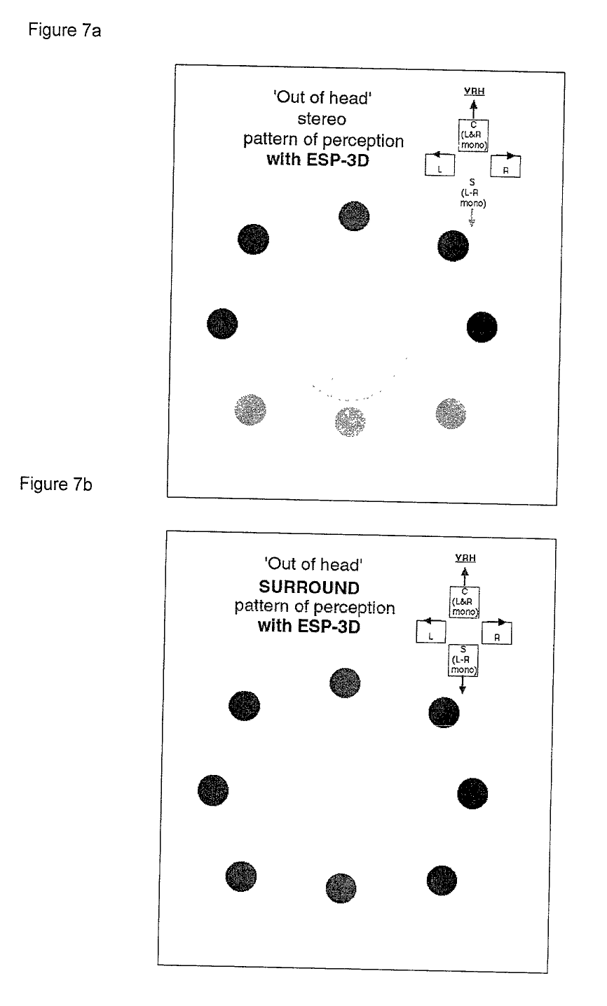

Referring to FIGS. 3 and 4, there is shown an embodiment of the present invention where a surround sound effect is created for the listener. In this embodiment, a rear channel signal 36 is provided. FIG. 3 shows how the four channels received at the input are redistributed, namely:

The front channel is equally sent to two transducers, one per headphone ear-cup;

The left channel goes to a left ear-cup transducer and the right channel goes to a right ear-cup transducer; and

The rear channel is equally sent to two transducers, one per headphone ear-cup.

The resulting perception of a listener that uses the set of headphones resembles a soundstage potential that goes all around his head, as shown in FIG. 4. The effect is the same as standing right in the “sweet-spot” of a surround sound system at home or in a theater, with the added advantage of eliminating room effects which normally degrade the surround sound simulation experienced by the listener.

As may further be seen in FIG. 4, the virtual point sources defining the pattern of perception of the listener are distributed all around his head 52. One will notice that there are some full behind the head surround (S), some behind the head towards the left side surround (-SL-) and also some behind the head towards the right side surround (-SR-). The same observation can be made of a between center and left (-CL-) and also of a between center and right (-CR-) virtual point source. This translates into coherent transitional perception in sound effects. As a matter of fact, the possible virtual point sources around a listener are virtually limitless, the only constraints being the zoning resolution of the surround sound matrixing process utilized in the mixing of the soundtrack being reproduced by the headphone of the present invention. The more natural, nuanced and ‘not choppy’ are the soundtracks being reproduced, the more natural the effect in surround perception. On the other hand, the more ‘choppy’ is the soundtrack in terms of matrixing processing at mixing, the more dramatic, although not natural the effect in surround perception. This is interesting for the headphone's applications in gaming and multimedia, since the typical PC or console gamer usually seeks some “high octane thrills”.

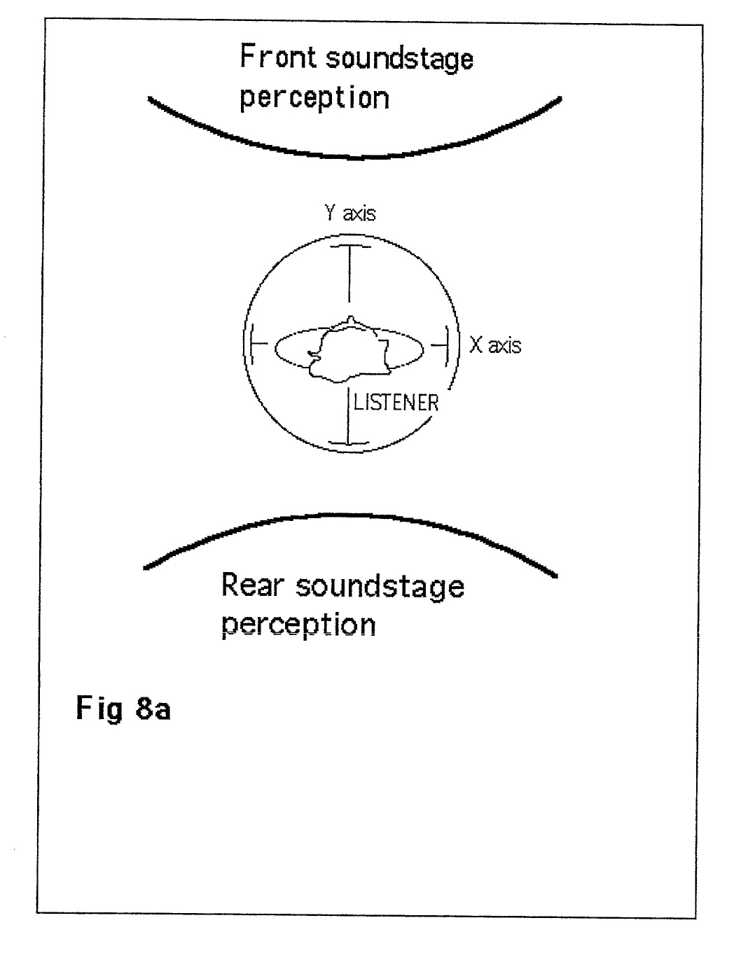

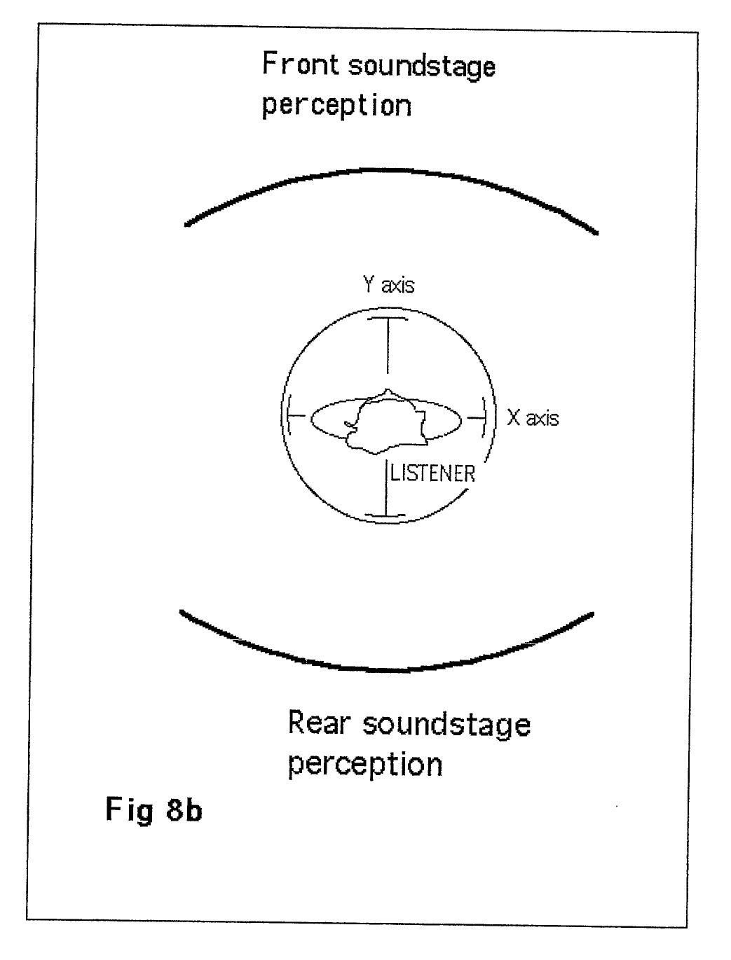

The potential for full surround perception does not imply that it is always desirable to be listening to music recordings in full surround mode. Indeed, when listening to stereophonic recordings of a classical concerto, for example, one might simply want to perceive a more coherent soundstage in front of him or her. Referring to FIGS. 5 and 6, there is shown a second embodiment of the invention where the rear channel signal is disconnected or not supplied at all. As shown in FIG. 6, the resulting sound perception is of a more natural, “out of head” stereophonic sound-staging in front of the listener.

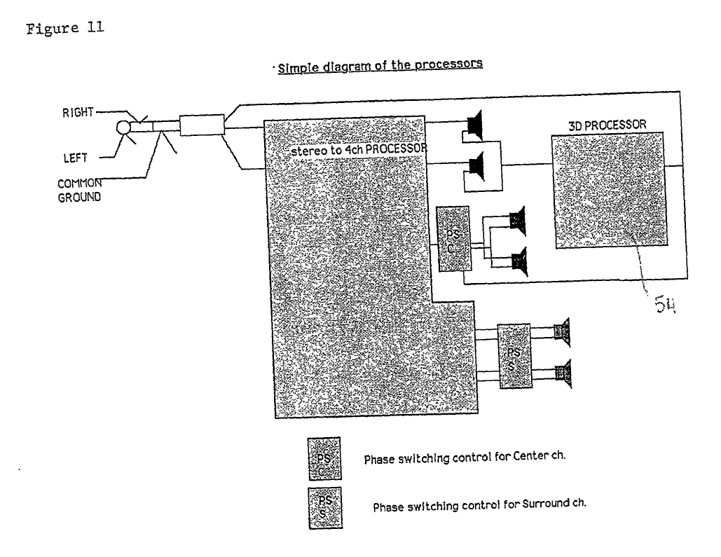

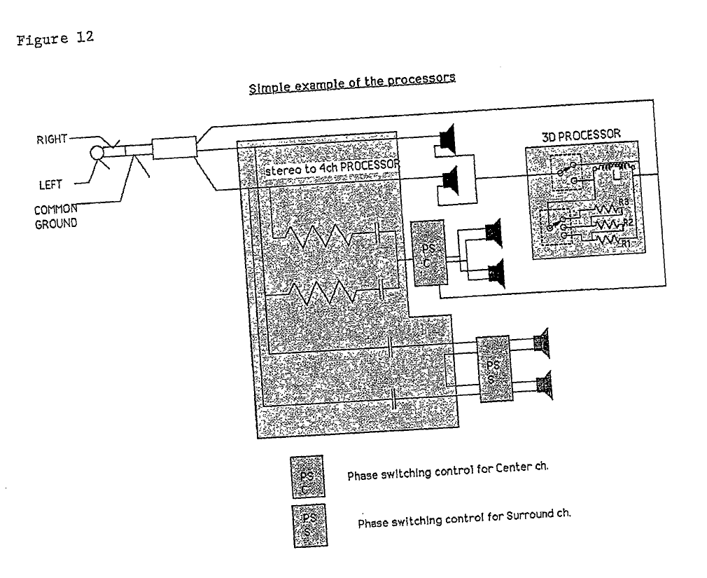

The circuitry and general block diagrams for an apparatus 20 according to the present invention are shown in FIGS. 11 and 12. The components of the sound channel may be directly provided by a surround sound system of any type. Alternatively, a stereophonic to surround sound decoding circuit 35, which receives a stereophonic signal 38a and 38b and decodes this stereophonic signal to produce the sound signal supplied into the input 28, may be included in the apparatus 20. Advantageously, the decoding circuit 35 may be of the type described in Applicant's own international application number PCT/CA97/00882, the content of which is incorporated herein by reference.

Referring still to FIGS. 11 and 12 in another aspect of the invention, the sound decoding circuit 35 may also include a 3D-processor 54. The 3D-processor 54 creates and plays with a ratio between the differentiated signals of a conventional stereophonic complementary signal, and the potential differential data that can be found in such a conventional stereophonic complementary signal. All of this without altering the fundamentals of sound. Such a 3D-processor is described in an application by the same inventor also filed on Dec. 22, 2000 and claiming priority of U.S. provisional patent application No. 60/171,655 of Dec. 27, 1999, the contents of which are incorporated herein by reference. the fundamental and the differential data are therefore combined and the result serves as a canvas for the differentiated spatial localization cues of the conventional stereophonic complementary signal data. One skilled in the art will readily understand why with relatively ‘non-purist’ soundtracks, the present invention could benefit from a 3D-processor as a user interfaced usable processor. It should however be noted that the 3D-processing must take place after the processing of the sound decoding circuit is done, otherwise there will not be enough data to extrapolate the center channel data.

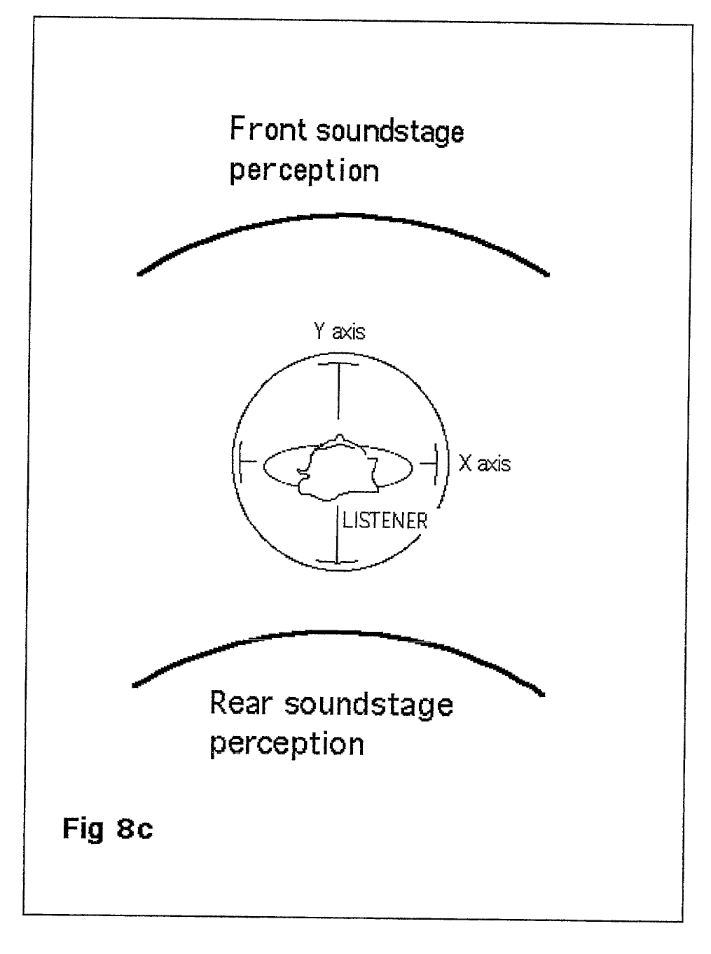

A benefit to the utilization of the 3D-processor in the present invention is that it leaves all of the fundamentals, that is the low frequencies, intact and fully reproduced by both the left and right ear-cup. This is advantageous in that low frequencies are usually ‘directionless’ due to the size of their wavelength, and the 3D processor offers a low frequency roll-off to the center imaging channel. In other words, the low frequencies from the left and right signal channels resulting from the use of the processor can substitute the low frequencies “missing” from the center imaging channel. This offers a more solid center stage imaging that still remains “out of head”. Another observed phenomenon is the apparent widening of the soundstage induced by the 3D-processor, as observed in regular stereophonic reproduction sound systems when using ESP-3D with two loudspeakers. This is for example illustrated in FIG. 7a. In another variant, the 3D-processor can also “enlarge” the surround soundstage, as shown in FIG. 7b.

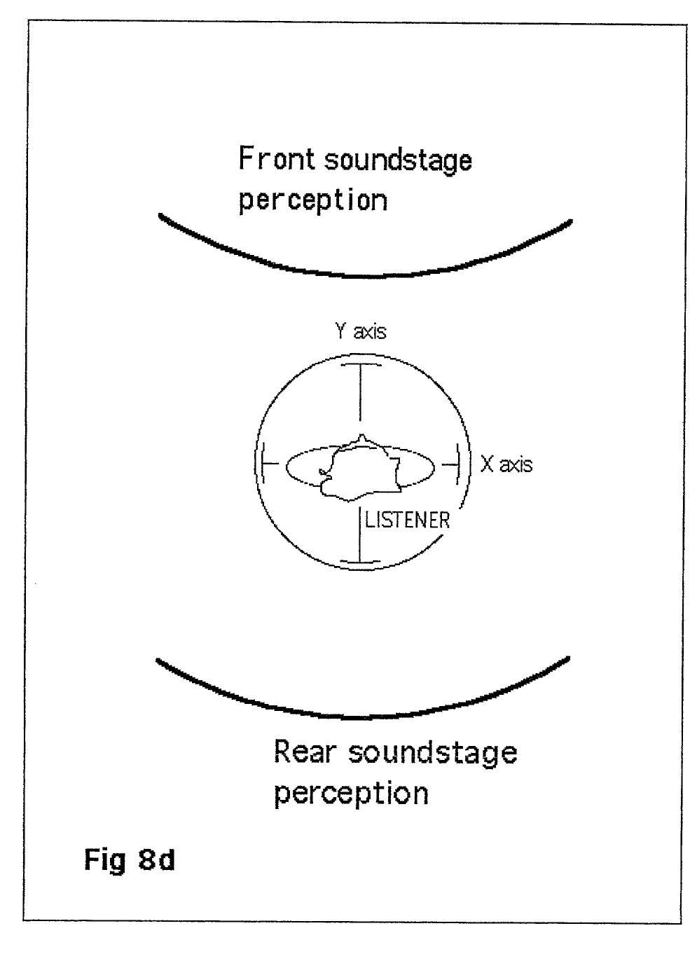

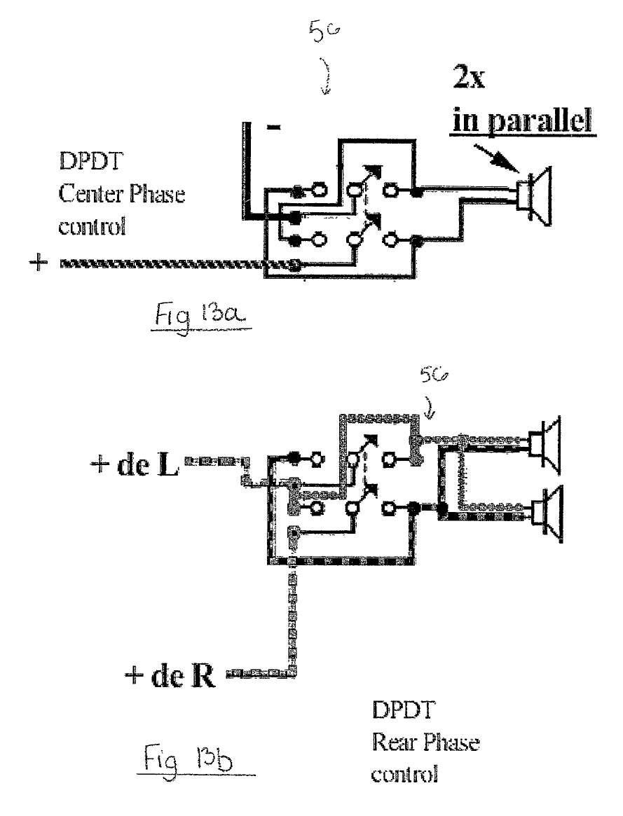

In another embodiment of the invention, phase adjusting means for adjusting the phase of each of the front and rear channel signals are provided. Referring to FIGS. 13a and 13b, such means may be embodied by a Dual Pole Dual Throw type switch 56, for example a slide switch, a toggle switch or a rotary switch. It has been observed that allowing users of VRH to control the acoustic phase of the front and rear channels independently, is advantageous. This phase switching capability can subjectively give the impression of a more intimate or a wider soundscape. It can also help with intelligibility in the dialogs on certain movie soundtracks, by ‘forcing’ the brain to do a better ‘tracking’ of the center channel. It is safe to say that in positive phase all around, one will perceive a smoother soundscape and that in reverse phase all around, one will perceive a ‘sharper’ soundscape. The use of various phase settings depends on the listener's personal preferences. FIGS. 8a to 8d show such possible settings.

In practice, the phase switching options can make a stunning difference that will be noticed at a glance. The more complex the soundscaping, the more likely the phase switching will be noticed and appreciated. It truly enhances the apparatus according to the present invention. For instance, if one prefers a larger soundscaping effect, the front and rear phases should both be set on negative. For a more intimate effect, the front and rear phases should be set on positive. Preferably, the design of the phase switching option system should ensure that when selecting the negative position for the front or rear, the phase control does not affect the low frequency range, hence the “canvas” for the sonic soundscapings.

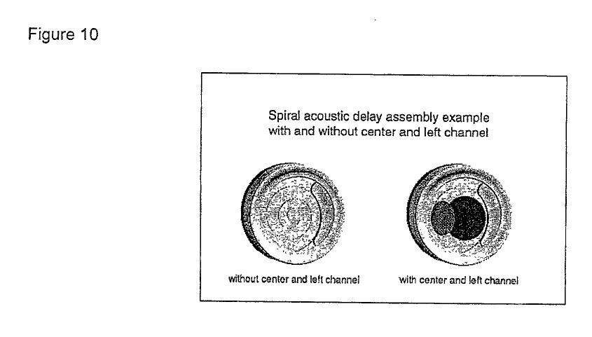

In still another embodiment of the invention, the left and right output means each include an acoustic delay line for introducing a delay of an order of a millisecond to the secondary rear channel signal with respect to the secondary front channel signal. The idea of acoustic delay for the surround channel is advantageous in that it allows for acoustic HTRF switching capability if so desired. In this embodiment, a miniature ‘transmission line’ enclosure for the rear channel transducer is placed in each ear-cup. A folded design, a spiral design or even an overhead tunnel assembly could possibly provide an acoustic delay of milliseconds required to place more emphasis on the surround channel separation from the ‘front’ staging area generated by the first and second, left and right transducers. The sound generated in such an acoustic delay assembly would get to the listeners ears via some slit openings at the back of each ear-cup assembly, preferably roughly where the third left and right transducers would normally be placed. By way of example, a spiral acoustic delay transmission line is shown in FIG. 10.

In yet another embodiment of the invention, preferably in conjunction with a delay line as explained above, the signals fed to the third transducers, is altered. In this embodiment, a copy of the right channel is fed to the third left transducer, preferably in inverted electrical phase. Similarly, a copy of the left channel is fed to the third right transducer, preferably in the same phase as the signal fed to the third left transducer. The listener therefore gets a form of HRTF correction effect for music or a movie soundtrack. This is not perfect by all means since the HTRF varies from person to person, but still, should provide an interesting and relatively coherent HRTF effect.

In accordance with another aspect of the invention, there is also provided a method for producing spatially distributed sound into a set of headphones having left and right ear-cups. The method includes the steps of:

a) receiving a sound signal including a left channel signal, a right channel signal, a front channel signal, and preferably a rear channel signal.

b) dividing the front channel signal into two secondary front channel signals, and if provided the rear channel signal into two secondary rear channel signals;

c) outputting the left channel signal and one of the secondary front channel signals into the left ear-cup. One of the secondary rear channel signals may also be outputted into the left ear-cup; and

d) outputting the right channel signal and another one of the secondary front channel signals into the right ear-cup. Similarly, another one of the secondary channel signals may be outputted into the right ear-cup.

Referring again to FIG. 2, in accordance with yet another aspect of the invention, there is provided a set of headphones 22 having a left ear-cup 24, a right ear-cup 26 and an apparatus 20 according to any of the embodiments described above.

Numerous applications for the headphones, apparatus and method according to the present invention can be found in various fields such as multimedia, music listening, movie listening, sound mixing in studios, etc. The present invention can be adapted to maximize the high output and dynamic capability of modern power amplifiers for a very high resolution version if need be, even if it is designed to work with low power levels associated with headphone amplifiers such as in walk-mans and computers.

Although the present invention has been described by way of preferred embodiments thereof, it should be understood that the invention is not limited to these precise embodiments, and that various changes and modifications may be effected without departing from the scope or spirit of the invention.

What is claimed is:

1. An apparatus for producing spatially distributed sound into a set of headphones having left and right ear-cups, said apparatus comprising:
an input for receiving a sound signal including a left channel signal, a right channel signal, and a front channel signal;
dividing means for dividing the front channel signal into two secondary front channel signals;
left output means for outputting the left channel signal and one of the secondary front channel signals into the left ear-cup; and
right output means for outputting the right channel signal and another one of the secondary front channel signals into the right ear-cup.

2. An apparatus according to claim 1, wherein:
the left output means include a first and a second left transducer for respectively outputting the left channel signal and the one of the secondary front channel signals; and
the right output means include a first and a second right transducer for respectively outputting the right channel signal and the other one of the secondary front channel signals.

3. An apparatus according to claim 2, wherein:
the left output means include a third left transducer for outputting a copy of the right channel signal; and
the right output means include a third right transducer for outputting a copy of the left channel signal.

4. An apparatus according to claim 1, wherein the sound signal includes a rear channel signal, the dividing means being adapted to divide said rear channel signal into two secondary rear channel signals, the left output means being adapted to output one of said secondary rear channel signals into the left ear-cup, and the right output means being adapted to output another one of said secondary rear channel signals into the right ear-cup.

5. An apparatus according to claim 4, wherein:
the left output means include a first, second and third left transducer for respectively outputting the left channel signals and each one of the secondary front and rear channel signals; and
the right output means include a first, second and third right transducer for respectively outputting the right channel signal and each of the other ones of the secondary front and rear channel signals.

6. An apparatus according to claim 4, further comprising a stereophonic to surround sound decoding circuit for receiving a stereophonic signal and decoding said stereophonic signal to produce the sound signal supplied into the input.

7. An apparatus according to claim 6, wherein said stereophonic to surround sound decoding circuit comprises a 3D processor.

8. An apparatus according to claim 4, further comprising phase adjusting means for adjusting the phase of each of the front and rear channel signals.

9. An apparatus according to claim 4, wherein the left and right output means each include an acoustic delay line for introducing a delay of an order of a millisecond to the secondary rear channel signal with respect to the secondary front channel signal.

10. A set of headphones, comprising a left ear-cup, a right ear-cup and an apparatus according to claim 4.

11. A set of headphones according to claim 10, wherein the first left and right transducers are disposed towards a front portion of a corresponding one of the left and right ear-cups, the second left and right transducers being disposed in a central portion of said corresponding ear-cup, and the third left and right transducers being disposed towards a rear portion of said corresponding ear-cup.

12. A method for producing spatially distributed sound into a set of headphones having left and right ear-cups, said method comprising the steps of:
a) receiving a sound signal including a left channel signal, a right channel signal, and a front channel signal;
b) dividing the front channel signal into two secondary front channel signals;
c) outputting the left channel signal and one of the secondary front channel signals into the left ear-cup; and
d) outputting the right channel signal and another one of the secondary front channel signals into the right ear-cup.

13. A method according to claim 12, wherein the sound signal received in step a) includes a rear channel signal, and said method further comprises:
in step b), dividing said rear channel signal into two secondary rear channel signals,
in step c), outputting one of said secondary rear channel signals into the left ear-cup; and
in step d), outputting another one of said secondary rear channel signals into the right ear-cup.
